(19) United States
(12) Patent Application Publication
(10) Pub. No.: US 2023/0102467 A1
(43) Pub. Date: Mar. 30, 2023

(54) METHOD OF DETECTING IMAGE, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Yue HE, Beijing (CN); Xiao TAN, Beijing (CN); Hao SUN, Beijing (CN)

(73) Assignee: BEIJING BAIDU NETCOM SCIENCE TECHNOLOGY CO., LTD., Beijing (CN)

(21) Appl. No.: 17/956,393

(22) Filed: Sep. 29, 2022

(30) Foreign Application Priority Data
Sep. 29, 2021 (CN) 202111155999.3

(51) Int. Cl. G06V 10/25; G06V 10/44; G06V 10/764; G06V 10/771; G06V 10/82

(52) U.S. Cl. CPC G06V 10/25; G06V 10/44; G06V 10/764; G06V 10/771; G06V 10/82; G06V 2201/07

(57) ABSTRACT

A method of detecting an image, an electronic device, and a storage medium are provided, which relate to a field of an artificial intelligence technology, in particular to fields of computer vision and deep learning technologies, and may be applied to a smart city and an intelligent cloud. The method includes: performing a feature extraction on an image to be detected, so as to obtain a feature map of the image to be detected; generating a prediction box in the feature map according to the feature map; generating a mask for the prediction box according to a key region of a target object; and classifying the prediction box using the mask as a classification enhancement information, so as to obtain a category of the prediction box.

This application claims priority to Chinese Patent Application No. 202111155999.3, filed on Sep. 29, 2021, the entire contents of which is incorporated herein in its entirety by reference.

### TECHNICAL FIELD

The present disclosure relates to a field of a computer technology, in particular to a field of an artificial intelligence technology, and specifically to a method of detecting an image, an electronic device, and a storage medium.

### BACKGROUND

In a practical application scene such as a surveillance scene, it is necessary to detect a target object in a surveillance image in real time. However, the target object in the surveillance image may overlap with other objects, so that a part of the target object may be occluded, which increases a difficulty of detecting the target object. In addition, in such a practical application scene, it is also required to have a high detection accuracy, a fast detection speed and a low hardware deployment cost.

### SUMMARY

The present disclosure provides a method of detecting an image, an electronic device, and a storage medium.

According to an aspect of the present disclosure, a method of detecting an image is provided, including: performing a feature extraction on an image to be detected, so as to obtain a feature map of the image to be detected; generating a prediction box in the feature map according to the feature map; generating a mask for the prediction box according to a key region of a target object; and classifying the prediction box using the mask as a classification enhancement information, so as to obtain a category of the prediction box.

According to an aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the method according to embodiments of the present disclosure.

According to an aspect of the present disclosure, a non-transitory computer-readable storage medium having computer instructions therein is provided, wherein the computer instructions are configured to cause a computer to implement the method according to embodiments of the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, wherein:

FIG. 1 shows a flowchart of a method of detecting an image according to embodiments of the present disclosure;

FIG. 2 shows a schematic diagram of an example of a residual block in a Resnet network according to embodiments of the present disclosure;

FIG. 3 shows a schematic diagram of an example of a residual block in a Resnet-D network according to embodiments of the present disclosure;

FIG. 4 shows a schematic diagram of a feature pyramid network structure;

FIG. 5 shows a schematic diagram of an example of a specific implementation of using a mask to enhance classification according to embodiments of the present disclosure;

FIG. 6 shows a schematic diagram of an apparatus of detecting an image according to embodiments of the present disclosure; and

FIG. 7 shows a schematic block diagram of an exemplary electronic device for implementing embodiments of the present disclosure.

### DETAILED DESCRIPTION OF EMBODIMENTS

Exemplary embodiments of the present disclosure will be described below with reference to the accompanying drawings, which include various details of embodiments of the present disclosure to facilitate understanding and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following description.

For example, in an elevator surveillance scene, it is possible to detect an electromobile in real time so that a function of preventing the electromobile from entering the elevator may be achieved. Due to an angle of a camera inside the elevator, an overlapping degree between multiple objects is high. If a target object is partially occluded by other object, it is easy to miss detection. In addition, there are a variety of electromobiles. Positive samples of an electromobile include electric motorcycle, electric bicycle, electric scooter, electric toy car, three/four-wheeled elderly scooter, etc. Similarly, negative samples of an electromobile include lightweight bicycle, non-electric toy car, handcart (baby carriage, wheelchair, small trailer, trolley, rod car), non-electric scooter, etc. A density and diversity of data brings a great difficulty to a detection task.

As an image detection algorithm needs to be deployed inside a hardware, a requirement on a video memory and a data volume of a detection model is very high. A model of Resnet50 and above may not meet the deployment requirement due to a large amount of data. A small model such as mobilenet and shufflenet may meet the deployment requirement, but has a low accuracy and may not accurately detect the electromobile, so that it is difficult to achieve the function of preventing the electromobile from entering the elevator.

Faster RCNN (Faster Region-based Convolutional Neural Network), SSD (Single Shot MultiBox Detector), YOLO (You Only Look Once) and other object detection models may be used to detect a target object in an image. Faster RCNN is a two-stage object detection model. In a first stage, a recommendation box is generated using a regional recommendation network, and in a second stage, a classification and a regression are performed on the recommendation box using a target classification network. SSD and YOLO are single-stage object detection models, in which the generation of the recommendation box and the subsequent classification and regression are integrated in one process. Different from the two-stage object detection model, the single-stage object detection model may improve the detection speed but reduce the accuracy.

The detection accuracy may be improved by the following methods.

In a method, for the two-stage object detection model, different sampling ratios may be used for positive samples and negative samples, so that the network model learns a certain proportion of positive and negative samples to avoid imbalance. This method has a problem that the two-stage object detection model is slow, and may not meet a speed requirement in a scene that requires a high real-time performance, such as the elevator surveillance scene.

In a method, a depth of a backbone network in the object detection model is increased, and a size of an input image is increased. This allows the detection model to learn more useful semantic information, so that a false detection of target object may be reduced. This method has a problem that the increase of the network depth and the image size may reduce the detection speed and increase the hardware deployment cost.

In a method, hard sample mining or other related algorithms and technologies is adopted to increase learning of a hard sample, so as to reduce a false detection of target object. This method has a problem that the hard sample mining technology such as OHEM (Online Hard Example Mining) and Focal Loss does not have obvious effects on all networks, for example, it has no practical effect on a YOLOV3 network.

In a method, a Feature Pyramid Network (FPN) structure is adopted. The FPN structure is designed with a top-down structure and a lateral connection, thereby combining a shallow information with a high resolution and a deep information with a rich semantic information. This method has a problem that more background information may be introduced in a high dimension.

In a method, an enhanced loss function, such as Intersection over Union (IoU) Loss, loss weight, etc. is adopted, so that a more suitable loss function may be designed according to different application requirements. This method has a problem that these enhanced loss functions may not be fully generalized. For example, IoU Loss performs poorly in a regression task.

None of the above methods is competent for an image detection task that has high requirements on detection accuracy, speed, and deployment cost.

The present disclosure provides a method of detecting an image, including: performing a feature extraction on an image to be detected, so as to obtain a feature map of the image to be detected; generating a prediction box in the feature map according to the feature map; generating a mask for the prediction box according to a key region of a target object; and classifying the prediction box using the mask as a classification enhancement information, so as to obtain a category of the prediction box. In this way, by using the key region of the target object as the classification enhancement information, it is beneficial to detect the target object in the image accurately and quickly, so that the requirements of the image detection task for the detection accuracy, speed and deployment cost may be met.

In the technical solution of the present disclosure, the collection, storage, use, processing, transmission, provision, disclosure and application of user's personal information and location involved are all in compliance with the provisions of relevant laws and regulations, and necessary confidentiality measures have been taken, and it does not violate public order and good morals. In the technical solution of the present disclosure, before obtaining or collecting the user's personal information, the user's authorization or consent is obtained.

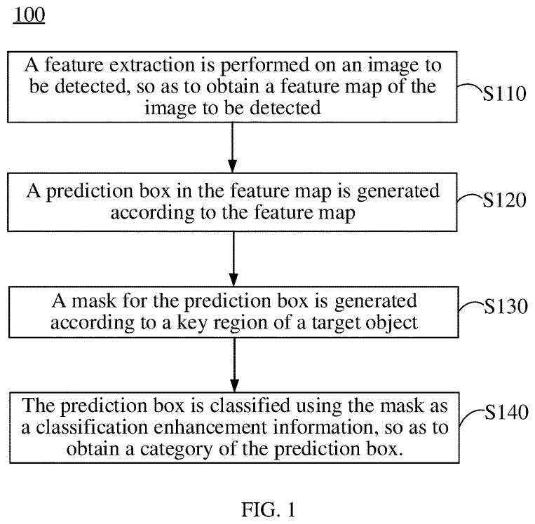

FIG. 1 shows a flowchart of a method 100 of detecting an image according to embodiments of the present disclosure. The method 100 of detecting the image according to embodiments of the present disclosure will be described below with reference to FIG. 1.

In step S110, a feature extraction is performed on an image to be detected, so as to obtain a feature map of the image to be detected.

In step S120, a prediction box in the feature map is generated according to the feature map.

In step S130, a mask for the prediction box is generated according to a key region of a target object.

In step S140, the prediction box is classified using the mask as a classification enhancement information, so as to obtain a category of the prediction box.

Features of the image may include a color feature, a texture feature, a shape feature, a spatial relationship feature, and the like. By extracting these features from the image to be detected, an original image with a large size may be projected into a low-dimensional feature space to form a feature map, which is convenient for subsequent object detection and classification. For example, if the image to be detected has a size of [W, H, 3], where W and H respectively represent a width and a height of the image to be detected, and 3 is the number of color channels of the image to be detected, then a size of the obtained feature map may be, for example, [W/16, H/16, 256], where 256 is the number of feature channels of the feature map. The image to be detected may be an image in any format, which is not limited in the present disclosure. Before extracting the features, preprocessing such as geometric transformation, image enhancement, and smoothing may be performed on the image to be detected, so as to remove an image acquisition error, eliminate an image noise, and improve an image quality.

A feature extraction method may include, for example, a convolutional neural network method, a histogram of oriented gradient (HOG) method, a local binary pattern (LBP) method, and a Haar-like feature method. Any feature extraction method may be adopt, which is not limited in the present disclosure.

In step S120, a plurality of prediction boxes are generated in the feature map, so that the category of an image in each prediction box of the plurality of prediction boxes may be detected in a subsequent step.

When generating the prediction box, a region proposal network (RPN) may be used to extract the prediction box from the feature map, and the prediction box is also called ROI.

The generation of the prediction box may include two processes: generating an initial prediction box; and performing a selection on the initial prediction box to obtain a final prediction box. The initial prediction box may be generated based on a similarity of the color, texture, etc. of a local region of the feature map (and the corresponding original image to be detected) according to a sliding window method, or using a fixed setting method of the prediction box.

For example, in the fixed setting method of the prediction box, for example, 9 preset initial prediction boxes with different sizes may be generated for each position on the feature map. Each prediction box on the feature map may also be converted into a prediction box on the original image to be detected. For example, if the size of the original image to be detected is [256, 256], and the size of the feature map is [16, 16], then coordinates [0, 1, 2 . . . 15] in a direction on the feature map may respectively correspond to coordinates [0, 16, 32 . . . 240] in a corresponding direction on the original image to be detected. Through this coordinate conversion method, a correspondence relationship may be formed between each position on the original image to be detected and each position on the feature map, so that the prediction box may be converted between the two.

In step S130, the key region of the target object includes at least one partial region contained in an entire region of the target object, and it is a critical region that distinguishes the target object from other object and that contains unique shape, size, color, texture and other features of the target object. Although the target object may be partially occluded by other object and the overall shape of the target object may not be detected, as long as the key region of the target object is detected, an existence of the target object may be detected accurately and quickly.

For example, in the elevator surveillance scene, due to a narrow space of the elevator and a limited angle of the camera, it is very likely that the target object is partially occluded by other object in the surveillance image. In this case, by using the key region of the target object such as an electromobile, the existence of the target object may be detected accurately and quickly, and it is not easy to miss detection.

The key region of the target object may also be used to accurately and quickly distinguish the target object from a similar object. For example, the electric motorcycle and the electric bicycle are two different categories of target objects, but have similar overall features. With existing object detection methods, it is difficult to distinguish the two accurately and quickly at low cost. However, this problem may be solved using the key region of the target object. For example, a seat width of the electric motorcycle is generally larger than that of the electric bicycle. For another example, a shape of a handle of the electric motorcycle is generally different from that of the electric bicycle. For another example, a shape of a wheel of the electric motorcycle is generally different from that of the electric bicycle. For another example, the electric motorcycle does not have pedals, while the electric bicycle has pedals. Through these key regions, the electric motorcycle and the electric bicycle may be distinguished accurately and quickly.

For each prediction box generated in step S120, a mask for the prediction box may be generated according to the key region of the target object to help determine the category of the prediction box. For example, an image sample of the key region of the target object may be acquired, and it may be determined whether a part of the image to be detected corresponding to the prediction box contains a corresponding image sample. If the corresponding image sample is contained, a position of the corresponding image sample in the prediction box may be determined. The above information is contained in an information called a mask.

As the key region of the target object is a local region in the entire region of the target object and is much smaller than the entire region of the target object, the processing of the key region needs little computation, so that a higher detection accuracy may be obtained at the cost of less computation.

In step S140, for each prediction box, if the mask for the prediction box indicates that the prediction box contains a feature corresponding to the key region of the target object, it may be determined that the category of the prediction box is the target object, or a confidence level of determining the category of the prediction box as the target object may be increased.

As described above, in the method 100 of detecting the image according to embodiments of the present disclosure, the key region of the target object may be used as the classification enhancement information to help detect the target object in the image accurately and quickly with little additional computation.

In an exemplary embodiment, generating the mask for the prediction box according to the key region of the target object (that is, step S130) may include: inputting the prediction box into a trained semantic segmentation model, so as to obtain the mask for the prediction box.

For example, a plurality of image samples of the key region of the target object may be acquired, so as to obtain a plurality of corresponding labeled image samples.

Then, the semantic segmentation model is trained with these labeled image samples, so that the trained semantic segmentation model may recognize any image to determine whether the image contains the key region of the target object and to determine a position of the key region if the key region of the target object is contained in the image. The trained semantic segmentation model may output a recognition result in a form of a mask.

Then, the part of the image to be detected corresponding to the prediction box may be input into the trained semantic segmentation model, and the mask for the part of the image (that is, the mask for the prediction box) may be obtained. For example, the part of the image to be detected corresponding to the prediction box may have a size of [m, n, c], where m and n respectively represent a width and a height of the part of the image to be detected, and c represents the number of color channels, then a size of the obtained mask may be, for example, [m, n, t], where t represents the number of categories determined by the semantic segmentation model. If a pixel at a specific position [m1, n1] (0≤m1≤m−1, 0≤n1n−1) in this part of the image to be detected is determined by the semantic segmentation model as a category t1 (0≤t1≤t−1), then a determination value for a t1^{th} category at the specific position [m1, n1] in the obtained mask is “1”, and a determination value for other category is “0”, so as to indicate that the category of the pixel at the specific position [m1, n1] is t1. The above is merely an example of a representation of the mask, but the present disclosure is not limited thereto, and any representation may be used.

The semantic segmentation model may determine the category of the target object for each pixel in the input image. The semantic segmentation model may be implemented by, for example, Fully Convolutional Networks (FCN), U-Net, PSPNet, and the like. However, the semantic segmentation model is not limited to these models, and may be implemented as any other suitable model.

The method of generating the mask for the prediction box is not limited to the specific examples described above. For example, instead of generating the mask based on the image to be detected as described above, the mask may also be generated directly based on the feature map. As long as the mask may be generated according to the key region of the target object to enhance the classification, any method of generating the mask that may be conceived by those skilled in the art may be adopted.

As the key region of the target object is a local region of the target object and is much smaller than the entire target object, training the semantic segmentation model and generating the mask by the semantic segmentation model need a small amount of computation, so that the accuracy of detecting the target object in the image may be increased with little additional computation.

In an exemplary embodiment, the method of detecting the image may further include a regression step, in which a coordinate regression is performed on the generated prediction box to obtain an updated prediction box. The regression step may be performed in parallel with the classification step. A regressor may be achieved by a trained regression model.

The prediction box generated in the step of generating the prediction box may not be accurately aligned with the target object, especially when the prediction box is set using a preset fixed position and size. Therefore, a regressor may be used to further fine-tune a bounding box position of the prediction box, so as to obtain a prediction box with a more accurate bounding box coordinate.

In an exemplary embodiment, a convolutional neural network (CNN) may be used as a backbone module when performing the feature extraction on the image to be detected.

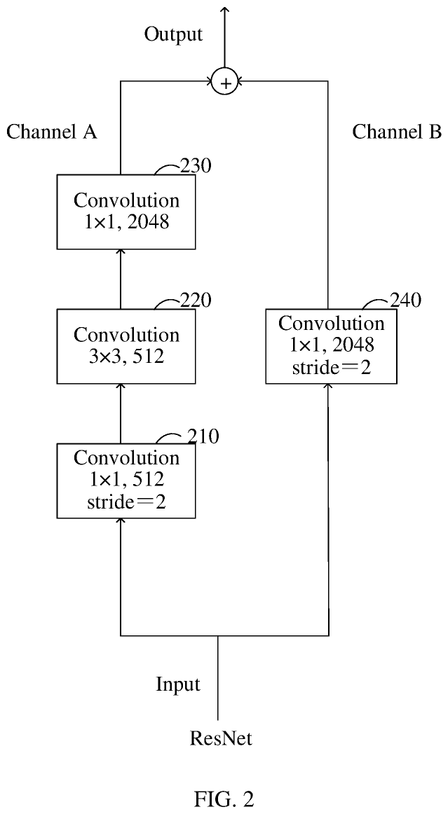

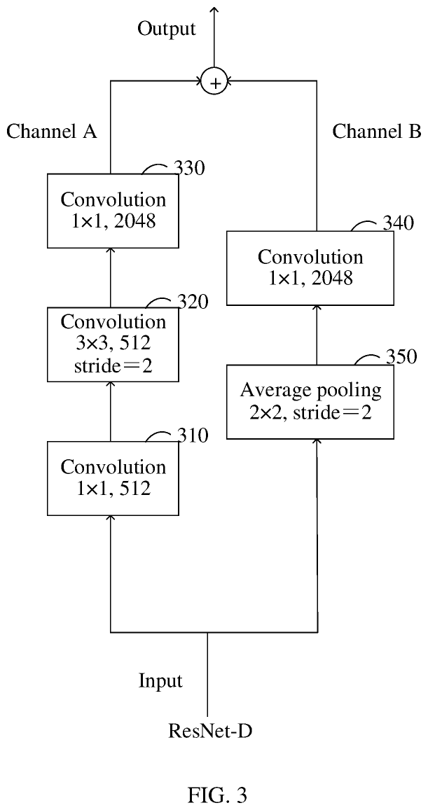

Specifically, a Resnet network (residual network), a Resnet-D network, or a ResneXt network may be used as the convolutional neural network. The convolutional neural network may include a plurality of cascaded convolutional units, and each convolutional unit consists of a plurality of residual blocks. FIG. 2 shows a diagram of an example of a residual block in a Resnet network according to embodiments of the present disclosure. FIG. 3 shows a diagram of an example of a residual block in a Resnet-D network according to embodiments of the present disclosure. The residual block in the Resnet network and the residual block in the Resnet-D network according to embodiments of the present disclosure will be described below with reference to FIG. 2 and FIG. 3.

As shown in FIG. 2, the residual block in the Resnet network includes channel A and channel B. The channel A includes three convolution operations, including a first convolution operation 210 with a convolution kernel size of 1×1, a channel number of 512 and a stride of 2, a second convolution operation 220 with a convolution kernel size of 3×3, a channel number of 512 and a stride of 1, and a third convolution operation 230 with a convolution kernel size of 1×1, a channel number of 2048 and a stride of 1. The channel B includes a convolution operation 240 with a convolution kernel size of 1×1, a channel number of 2048 and a stride of 2. In such a residual block, the first convolution operation 210 of the channel A and the first convolution operation 240 of the channel B have the stride of 2, and these convolution operations may lose part of the information in the input feature map.

As shown in FIG. 3, an improvement is made in the residual block in the Resnet-D network. In the channel A, a stride of a first convolution operation 310 is modified to 1, a stride of a second convolution operation 320 is modified to 2, and a stride of a third convolution operation 330 remains unchanged. In the channel B, an average pooling operation 350 with a stride of 2 is added before a convolution operation 340, and a stride of the convolution operation 340 is modified to 1. In this way, the information in the input feature map may not be lost in both the channel A and the channel B. Therefore, different from the use of the Resnet network, the use of the Resnet-D network may achieve a higher model accuracy with little additional computation.

In an exemplary embodiment, at least one stage of convolutional unit among the plurality of cascaded convolutional units may include a deformable convolutional (DCN) unit. For example, a last stage of the convolution unit among the plurality of cascaded convolution units may include a deformable convolution unit.

A deformable convolution refers to additionally adding a direction parameter to each element of the convolution kernel, so that the convolution kernel may be expanded to a larger range. The direction parameter may be learned for each position on the feature map. For example, the direction parameter may be an offset value. An existing convolution kernel is fixed, which has a poor adaptability to unknown changes and a weak generalization ability. In a same layer of the convolutional neural network, different positions may correspond to objects with different scales or different deformations. For example, a cat and a horse have significantly different sizes and shapes. The existing convolution kernel is difficult to adapt to this change. The deformable convolution may automatically adjust a shape or a receptive field adaptively according to different positions, so that the features may be extracted more accurately.

The deformable convolution may be applied to any one or more convolution units among the plurality of cascaded convolution units according to an actual situation. For example, it may be applied to the last stage of convolutional unit among the plurality of cascaded convolutional units to improve the model accuracy with little additional computation.

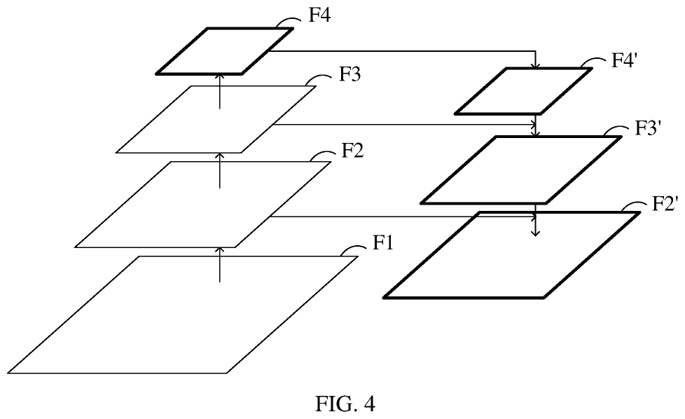

In an exemplary embodiment, the convolutional neural network may adopt ResNet18vd-DCN, for example. ResNet18vd-DCN refers to a ResNet-D network with 18 convolutional layers, and includes a deformable convolution DCN. Considering the requirements for the detection accuracy and real-time performance, it is appropriate to use 18 convolutional layers. As shown in FIG. 3 and FIG. 4, by using the ResNet-D network, the model accuracy may be increased with almost no increase in the amount of computation. The image feature may be extracted more accurately using the deformable convolution.

The convolutional neural network is not limited to ResNet18vd-DCN, but may be implemented in various ways that may be conceived by those skilled in the art, which is not particularly limited in the present disclosure.

In an exemplary embodiment, the plurality of cascaded convolutional units may include at least one dilated convolutional unit. A dilated convolution is also called an atrous convolution, in which a hole is added on the basis of an existing convolution to increase the receptive field, so that the output may contain a wider range of information and the feature extraction network may extract more feature information of large-scale target object. Because a computational cost of using the dilated convolution is high, the convolutional neural network may include an appropriate number of dilated convolution unit according to actual needs, so as to take into account both real-time and accuracy requirements.

In an exemplary embodiment, when performing the feature extraction, a feature pyramid network structure may be combined into the convolutional neural network to generate a multi-scale fusion feature map by fusing features of a plurality of levels of different scales of the image to be detected, which is used as the feature map of the image to be detected.

FIG. 4 shows a schematic diagram of the feature pyramid network structure. A principle of the feature pyramid network (FPN) structure will be described below with reference to FIG. 4.

A feature pyramid may be a pyramid-shaped structure constructed between feature maps. For example, a convolutional neural network includes five cascaded convolutional units C1, C2, C3, C4 and C5. The convolution units C2, C3, C4 and C5 output four feature maps F1, F2, F3 and F4 shown on a left side of FIG. 4, respectively. F1 contains a low-level fine-grained semantic feature, and F4 contains a high-level coarse-grained semantic feature.

The feature pyramid may fuse the high-level feature and the low-level feature to obtain more comprehensive information. For example, as shown on a right side of FIG. 4, in the feature pyramid structure, the high-level feature map F4 may be determined as a feature map F4′, and the high-level feature map F4 may be enlarged to have the same size as the feature map F3 by up-sampling it. Then, a 1×1 convolution operation is performed on the feature map F3 to change its number of channels. Then, the F3 with the changed number of channels is added to the enlarged F4′ to obtain a new feature map F3′. Similarly, the F2 with a changed number of channels is added to an enlarged F3′ to obtain a new feature map F2′. In this way, the low-level semantic information and high-level semantic information of each layer are fused in the new feature map F2′, so that the features may be extracted more comprehensively.

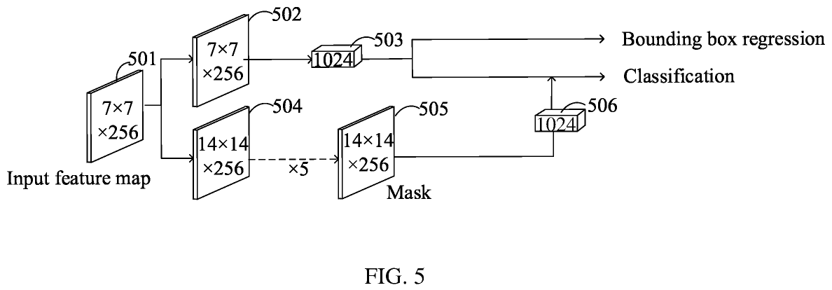

In an exemplary embodiment, the generated mask for the prediction box is used to enhance the classification and is not output as a detection result alone. FIG. 5 schematically shows a diagram of an example of a specific implementation method of using a mask for enhancing the classification according to embodiments of the present disclosure. As shown in FIG. 5, a feature map 501 may correspond to a prediction box. The feature map 501 may be used as an input feature map, which is input respectively into two branches in an upper row and a lower row shown in FIG. 5. In the branch in the upper row, a convolution operation is performed on the feature map 501 to obtain a feature map 502 with a size of 7×7 and a channel number of 256, and then a fully connected layer operation is performed on the feature map 502 to obtain a feature map 503 with a size of 1×1 and a channel number of 1024. Next, the feature map 503 is input into a bounding box regression module and a classification module respectively for a bounding box regression and a classification. In the branch in the lower row, a deconvolution operation is performed on the feature map 501 to obtain a feature map 504 with a size of 14×14 and a channel number of 256, and then a convolution operation is repeatedly performed on the feature map 504 for five times to obtain a mask 505 with a size of 14×14 and a channel number of 256. Next, a fully connected layer operation is performed on the mask 505 to convert the mask 505 into a feature map 506 with a size of 1×1 and a channel number of 1024, and the feature map 506 is input into the classification module to be concatenated with the feature map with the same size and channel number in the classification module. In this way, the mask may be used as the classification enhancement information in the classification module to classify the prediction box.

Those skilled in the art may understand that FIG. 5 is only a schematic example of a specific implementation method of using a mask for enhancing the classification. Therefore, the size and channel number of each feature map and various operations performed on the feature maps shown in FIG. 5 are examples and are not intended to limit the network structure of the present disclosure to this example.

In an exemplary embodiment, in a training stage, a mask module may perform supervision on loss together with the classification module and the regression module. The mask module may use, for example, a cross-entropy loss function, the regression module may use, for example, a smoothl1 loss function, and the classification module may use, for example, a cross-entropy loss function. A total loss function may be expressed as:

Lₜₒₜₐₗ=λ1×Lₘₐₛₖ+λ₂×L_{regression}+λ3×L_{classification},

wherein λ1, λ2, λ3 are preset weight coefficients, Lₜₒₜₐₗ represents a total loss of the mask module, the classification module and the regression module, Lₘₐₛₖ represents a loss of the mask module, L_{regression} represents a loss of the regression module, and L_{classification} represents a loss of the classification module.

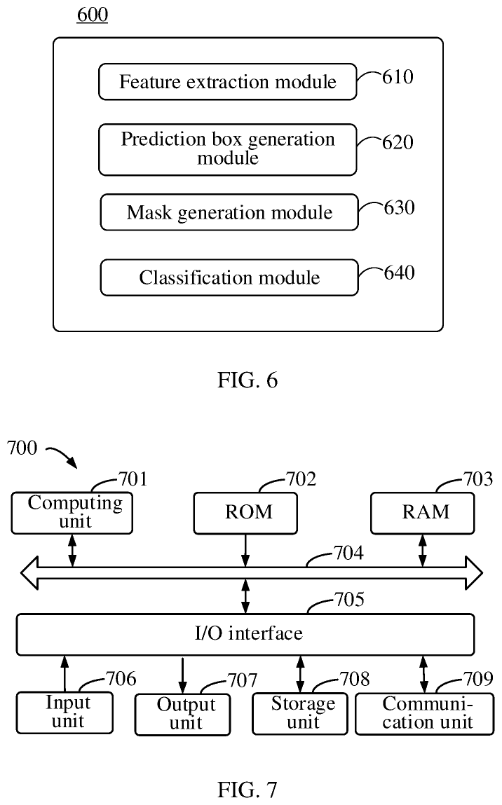

FIG. 6 shows a schematic diagram of an apparatus 600 of detecting an image according to embodiments of the present disclosure. The apparatus of detecting the image according to embodiments of the present disclosure will be described below with reference to FIG. 6. The apparatus 600 of detecting the image includes a feature extraction module 610, a prediction box generation module 620, a mask generation module 630 and a classification module 640.

The feature extraction module 610 is used to perform a feature extraction on an image to be detected, so as to obtain a feature map of the image to be detected.

The prediction box generation module 620 is used to generate a prediction box in the feature map according to the feature map.

The mask generation module 630 is used to generate a mask for the prediction box according to a key region of a target object.

The classification module 640 is used to classify the prediction box using the mask as a classification enhancement information, so as to obtain a category of the prediction box.

According to the apparatus 600 of detecting the image, by using the key region of the target object as the classification enhancement information, it is possible to detect the target object in the image accurately and quickly with little additional computation, so that the requirements of the image detection task for the detection accuracy, speed and deployment cost may be met.

Although a specific example of detecting an electromobile in an elevator surveillance scene is given in the above embodiments, those skilled in the art may understand that this example is not intended to limit the scope of the present disclosure, and the method and the apparatus of detecting the image of the present disclosure may be applied to various image detection scenes.

According to embodiments of the present disclosure, the present disclosure further provides an electronic device, a readable storage medium, and a computer program product, which may also help detect the target object in the image accurately and quickly with little additional computation by using the key region of the target object as the classification enhancement information, so that the requirements of the image detection task for the detection accuracy, speed and deployment cost may be met.

FIG. 7 shows a schematic block diagram of an exemplary electronic device 700 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 7, the electronic device 700 includes a computing unit 701 which may perform various appropriate actions and processes according to a computer program stored in a read only memory (ROM) 702 or a computer program loaded from a storage unit 708 into a random access memory (RAM) 703. In the RAM 703, various programs and data necessary for an operation of the device 700 may also be stored. The computing unit 701, the ROM 702, and the RAM 703 are connected to each other through a bus 704. An input/output (I/O) interface 705 is also connected to the bus 704.

A plurality of components in the electronic device 700 are connected to the I/O interface 705, including: an input unit 706, such as a keyboard, or a mouse; an output unit 707, such as displays or speakers of various types; a storage unit 708, such as a disk, or an optical disc; and a communication unit 709, such as a network card, a modem, or a wireless communication transceiver. The communication unit 709 allows the electronic device 700 to exchange information/data with other devices through a computer network such as Internet and/or various telecommunication networks.

The computing unit 701 may be various general-purpose and/or a dedicated processing assemblies having processing and computing capabilities. Some examples of the computing units 701 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 701 executes various methods and processing described above, such as the method of detecting the image described above. For example, in some embodiments, the method may be implemented as a computer software program which is tangibly embodied in a machine-readable medium, such as the storage unit 708. In some embodiments, the computer program may be partially or entirely loaded and/or installed in the electronic device 700 via the ROM 702 and/or the communication unit 709. The computer program, when loaded in the RAM 703 and executed by the computing unit 701, may execute one or more steps in the method of detecting the image described above. Alternatively, in other embodiments, the computing unit 701 may be configured to execute the above-described method by any other suitable means (e.g., by means of firmware). The electronic device 700 may be, for example, a control center of a distributed system, or any device located inside or outside a distributed system. The electronic device 700 is not limited to the above examples, as long as the above-described method may be implemented.

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a load programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, a magnetic, an optical, an electromagnetic, an infrared, or a semiconductor system, apparatus, or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

A computer system may include a client and a server. The client and the server are generally far away from each other and usually interact through a communication network. The relationship between the client and the server is generated through computer programs running on the corresponding computers and having a client-server relationship with each other. The server may be a cloud server or a server of distributed system or a server combined with block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of detecting an image, the method comprising:
performing a feature extraction on an image to be detected, so as to obtain a feature map of the image to be detected;
generating a prediction box in the feature map according to the feature map;
generating a mask for the prediction box according to a key region of a target object; and
classifying the prediction box using the mask as a classification enhancement information, so as to obtain a category of the prediction box.

2. The method according to claim 1, wherein the generating a mask for the prediction box according to a key region of a target object comprises inputting the prediction box into a trained semantic segmentation model, so as to obtain the mask for the prediction box.

3. The method according to claim 1, further comprising performing a coordinate regression on the prediction box, so as to obtain an updated prediction box.

4. The method according to claim 1, wherein the performing a feature extraction on an image to be detected so as to obtain a feature map of the image to be detected comprises performing, by using a convolutional neural network, the feature extraction on the image to be detected, so as to obtain the feature map of the image to be detected, wherein the convolutional neural network comprises a plurality of cascaded convolutional units, and a last stage of convolutional unit among the plurality of cascaded convolutional units comprises a deformable convolutional unit.

5. The method according to claim 4, wherein the plurality of cascaded convolutional units comprise at least one dilated convolutional unit.

6. The method according to claim 2, further comprising performing a coordinate regression on the prediction box, so as to obtain an updated prediction box.

7. The method according to claim 2, wherein the performing a feature extraction on an image to be detected so as to obtain a feature map of the image to be detected comprises performing, by using a convolutional neural network, the feature extraction on the image to be detected, so as to obtain the feature map of the image to be detected, wherein the convolutional neural network comprises a plurality of cascaded convolutional units, and a last stage of convolutional unit among the plurality of cascaded convolutional units comprises a deformable convolutional unit.

8. The method according to claim 3, wherein the performing a feature extraction on an image to be detected so as to obtain a feature map of the image to be detected comprises performing, by using a convolutional neural network, the feature extraction on the image to be detected, so as to obtain the feature map of the image to be detected, wherein the convolutional neural network comprises a plurality of cascaded convolutional units, and a last stage of convolutional unit among the plurality of cascaded convolutional units comprises a deformable convolutional unit.

9. An electronic device, comprising:
at least one processor; and
a memory communicatively connected to the at least one processor, wherein the memory stores instructions executable by the at least one processor, and the instructions, when executed by the at least one processor, cause the at least one processor to at least:
perform a feature extraction on an image to be detected, so as to obtain a feature map of the image to be detected;
generate a prediction box in the feature map according to the feature map;
generate a mask for the prediction box according to a key region of a target object; and
classify the prediction box using the mask as a classification enhancement information, so as to obtain a category of the prediction box.

10. The electronic device according to claim 9, wherein the instructions are further configured to cause the at least one processor to at least input the prediction box into a trained semantic segmentation model, so as to obtain the mask for the prediction box.

11. The electronic device according to claim 9, wherein the instructions are further configured to cause the at least one processor to at least perform a coordinate regression on the prediction box, so as to obtain an updated prediction box.

12. The electronic device according to claim 10, wherein the instructions are further configured to cause the at least one processor to at least perform a coordinate regression on the prediction box, so as to obtain an updated prediction box.

13. The electronic device according to claim 9, wherein the instructions are further configured to cause the at least one processor to at least perform, by using a convolutional neural network, the feature extraction on the image to be detected, so as to obtain the feature map of the image to be detected, wherein the convolutional neural network comprises a plurality of cascaded convolutional units, and a last stage of convolutional unit among the plurality of cascaded convolutional units comprises a deformable convolutional unit.

14. The electronic device according to claim 10, wherein the instructions are further configured to cause the at least one processor to at least perform, by using a convolutional neural network, the feature extraction on the image to be detected, so as to obtain the feature map of the image to be detected, wherein the convolutional neural network comprises a plurality of cascaded convolutional units, and a last stage of convolutional unit among the plurality of cascaded convolutional units comprises a deformable convolutional unit.

15. The electronic device according to claim 11, wherein the instructions are further configured to cause the at least one processor to at least perform, by using a convolutional neural network, the feature extraction on the image to be detected, so as to obtain the feature map of the image to be detected, wherein the convolutional neural network comprises a plurality of cascaded convolutional units, and a last stage of convolutional unit among the plurality of cascaded convolutional units comprises a deformable convolutional unit.

16. The electronic device according to claim 13, wherein the plurality of cascaded convolutional units comprise at least one dilated convolutional unit.

17. A non-transitory computer-readable storage medium having computer instructions therein, wherein the computer instructions are configured to cause a computer system to at least:
perform a feature extraction on an image to be detected, so as to obtain a feature map of the image to be detected;
generate a prediction box in the feature map according to the feature map;
generate a mask for the prediction box according to a key region of a target object; and
classify the prediction box using the mask as a classification enhancement information, so as to obtain a category of the prediction box.

18. The non-transitory computer-readable storage medium according to claim 17, wherein the instructions are further configured to cause the computer system to at least input the prediction box into a trained semantic segmentation model, so as to obtain the mask for the prediction box.

19. The non-transitory computer-readable storage medium according to claim 17, wherein the instructions are further configured to cause the computer to at least perform a coordinate regression on the prediction box, so as to obtain an updated prediction box.

20. The non-transitory computer-readable storage medium according to claim 17, wherein the instructions are further configured to cause the computer to at least perform, by using a convolutional neural network, the feature extraction on the image to be detected, so as to obtain the feature map of the image to be detected, wherein the convolutional neural network comprises a plurality of cascaded convolutional units, and a last stage of convolutional unit among the plurality of cascaded convolutional units comprises a deformable convolutional unit.
